(19) United States
(12) Patent Application Publication
(10) Pub. No.: US 2025/0076105 A1
(43) Pub. Date: Mar. 6, 2025

(54) DUAL-PORT OPTICAL TRANSMITTING AND RECEIVING MODULE

(71) Applicant: Molex, LLC, Lisle, IL (US)

(72) Inventors: Yan-Bing Zhang, Guangdong (CN); Yong Du, Guangdong (CN); Yi Liao, San Jose, CA (US); Jinyuan Qiao, Cupertino, CA (US); Xiao Feng Xiong, Guangdong (CN); Jian-Long Huang, Guangdong (CN)

(21) Appl. No.: 18/818,649

(22) Filed: Aug. 29, 2024

(30) Foreign Application Priority Data
Aug. 31, 2023 (CN) 202311119937.6

(51) Int. Cl. G01H 9/00; H01S 3/067

(52) U.S. Cl. CPC G01H 9/004; H01S 3/06716

(57) ABSTRACT

A dual-port optical transmitting and receiving assembly, comprising an optical transmitting group, an optical circulator, a light turning element, a first input/output terminal, a second input/output terminal, and an optical receiving group. The first input/output terminal and the second input/output terminal are disposed in a spaced arrangement. A first signal light emitted from the optical transmitting group passes through the optical circulator and enters the first input/output terminal. A second signal light emitted from the optical transmitting group passes through the optical circulator. Then, it enters the second input/output terminal after being reflected by the light turning element. A third signal light from the first input/output terminal passes through the optical circulator and enters the optical receiving group. A fourth signal light from the second input/output terminal is reflected by the light turning element and enters the optical receiving group after passing through the optical circulator.

### TECHNICAL FIELD

The present disclosure relates to the technical field of optical fiber communication and relates in particular to a dual-port optical transmitting and receiving module.

### BACKGROUND

At present, structural devices with different structural layouts can be correspondingly formed for dual-port optical transmitting and receiving assemblies according to different purposes of use. For example, a dual-input/output port may receive signals of different wavelengths or emit signals of two different wavelengths. Therefore, for different modes of use, the dual-port optical transmitting and receiving assembly usually needs corresponding structural components to meet the corresponding requirements of use. In addition, conventional dual-port optical transmitting and receiving assemblies use discrete light-splitting core assemblies and optical transmitting and receiving groups. These occupy a large module space, making it impossible for them to be compatible, in terms of size, with the small form factor pluggable-dual density (SFP-DD) multi-source agreement (MSA) standard (with a two-port spacing of 6.25 mm, IEC61754-20). Further, conventional dual-port optical transmitting and receiving assemblies have a high cost, which is disadvantageous for the integration of dual-port optical transmitting and receiving assemblies.

### SUMMARY

It is an object of one or more embodiments to provide a dual-port optical transmitting and receiving assembly with a small size and a high channel utilization rate by solving the deficiencies in the prior art. One or more embodiments include an optical transmitting group, an optical circulator, a light turning element, a first input/output terminal, a second input/output terminal, and an optical receiving group. The first input/output terminal and the second input/output terminal are disposed in a spaced arrangement, which allows for a small size and a high channel utilization rate.

In one or more embodiments by means of the optical transmitting group, the circulator assembly, and the light turning element, the above dual-port optical transmitting and receiving assembly can realize that two signal lights enter the first input/output terminal and the second input/output terminal from the optical transmitting group, respectively. The one or more embodiments can also realize that another two signal lights are transmitted from the first input/output terminal and the second input/output terminal to the optical receiving group, respectively. Therefore, the present disclosure's dual-port optical transmitting and receiving assembly includes four optical paths, and the four optical paths each use the same set of light-splitting core components (optical circulator and light turning element), the optical transmitting group, and the optical receiving group. This can achieve an extremely high degree of integration, improving the space utilization rate and making the dual-port optical transmitting and receiving assembly of the present disclosure compatible with the small form factor pluggable-double density (SFP-DD) multi-source agreement (MSA) standard in terms of size and costs. Also, since the optical circulator is used to realize the transmission and reception of the optical paths, the dual-port optical transmitting and receiving assembly has the characteristics of low loss and insensitivity to polarization.

### BRIEF DESCRIPTION OF THE DRAWINGS

The organization and manner of the structure and operation of the present disclosure, together with further objects and advantages thereof, may best be understood by reference to the following Detailed Description, taken in connection with the accompanying Figures, wherein like reference numerals identify like elements, and in which:

FIG. 1 is a schematic structural diagram of a dual-port optical transmitting and receiving assembly using a dual-path optical transmitting group with the same wavelength;

FIG. 2 is a schematic structural diagram of the dual-port optical transmitting and receiving assembly using the dual-path optical transmitting group with the same wavelength;

FIG. 3 is a schematic structural diagram of an optical circulator shown in FIG. 1;

FIG. 4 is an optical path diagram of the optical circulator shown in FIG. 3;

FIG. 5 is an optical path diagram of two signal lights being transmitted from the dual-port optical transmitting and receiving assembly using the dual-path optical transmitting group with the same wavelength to two input/output terminals;

FIG. 6 is an optical path diagram of the first signal light shown in FIG. 5;

FIG. 7 is an optical path diagram of the second signal light shown in FIG. 5;

FIG. 8 is another optical path diagram of the optical circulator shown in FIG. 1;

FIG. 9 is an optical path diagram of two signal lights of a dual-port optical transmitting and receiving assembly being transmitted from two input/output terminals to an optical receiving group;

FIG. 10 is an optical path diagram of the third signal light shown in FIG. 9;

FIG. 11 is an optical path diagram of the fourth signal light shown in FIG. 9;

FIG. 12 is a schematic structural diagram of a dual-port optical transmitting and receiving assembly using a wavelength-adjustable optical transmitting group;

FIG. 13 is an optical path diagram of two signal lights of the dual-port optical transmitting and receiving assembly shown in FIG. 12 being transmitted from an optical transmitting group to two input/output terminals;

FIG. 14 is an optical path diagram of the first signal light shown in FIG. 13;

FIG. 15 is an optical path diagram of the second signal light shown in FIG. 13;

FIG. 16 is a schematic structural diagram of the light turning element shown in FIG. 13;

FIG. 17 is an optical path diagram of the light turning element shown in FIG. 16;

FIG. 18 is a schematic structural diagram of the dual-port optical transmitting and receiving assembly using the wavelength-adjustable optical transmitting group;

FIG. 19 is an optical path diagram of two signal lights of the dual-port optical transmitting and receiving assembly shown in FIG. 18 being transmitted from an optical transmitting group to two input/output terminals;

FIG. 20 is a schematic structural diagram of the dual-port optical transmitting and receiving assembly using the wavelength-adjustable optical transmitting group;

FIG. 21 is an optical path diagram of two signal lights of the dual-port optical transmitting and receiving assembly shown in FIG. 20 being transmitted from an optical transmitting group to two input/output terminals;

FIG. 22 is an optical path diagram of two signal lights of the dual-port optical transmitting and receiving assembly shown in FIG. 12 being transmitted from two input/output terminals to an optical receiving group;

FIG. 23 is an optical path diagram of a third signal light shown in FIG. 22;

FIG. 24 is an optical path diagram of a fourth signal light shown in FIG. 22;

FIG. 25 is an optical path diagram of signal lights of the dual-port optical transmitting and receiving assembly shown in FIG. 18 being transmitted from two input/output terminals to an optical receiving group; and

FIG. 26 is an optical path diagram of signal lights of the dual-port optical transmitting and receiving assembly shown in FIG. 20 being transmitted from two input/output terminals to an optical receiving group. Description of reference numerals of the accompanying drawings: 1. optical transmitting group; 11. first lens; 2. optical circulator; 21. first polarization beam splitter; 211. total reflection surface; 22. second polarization beam splitter; 23. wave plate; 24. Faraday rotator assembly; 3. light turning element; 4. first input/output terminal; 5. second input/output terminal; 6. optical receiving group; 61. second lens; 7. filter; 71. optical shift element; 8. light-absorbing plate; 9. diaphragm; 91. opening; 10. housing.

### DETAILED DESCRIPTION

Typical embodiments that embody the features and advantages of the present disclosure will be described in detail in the following description. It should be understood that the present disclosure may have various changes in different embodiments without departing from the scope of the present disclosure and that the descriptions and illustrations therein are essentially for illustrative purposes rather than for limiting the present disclosure.

In the description of the present application, it should be understood that in the embodiments shown in the drawings, the indications of directions or positional relationships (such as up, down, left, right, front and rear, etc.) are only for the convenience of describing the present application and simplifying the description, and do not indicate or imply that devices or elements referred to must have specific orientations, be constructed and operated in specific orientations. When these elements are in the positions shown in the drawings, these descriptions are appropriate. If the descriptions of the positions of these elements change, the indications of these directions also change accordingly.

In addition, the terms “first” and “second” are only used for descriptive purposes and cannot be understood as indicating or implying relative importance or implicitly indicating the number of technical features indicated. Thus, features defined with “first” and “second” may explicitly or implicitly include one or more of the described features. In the description of the present application, “a plurality” means two or more unless otherwise clearly and specifically defined.

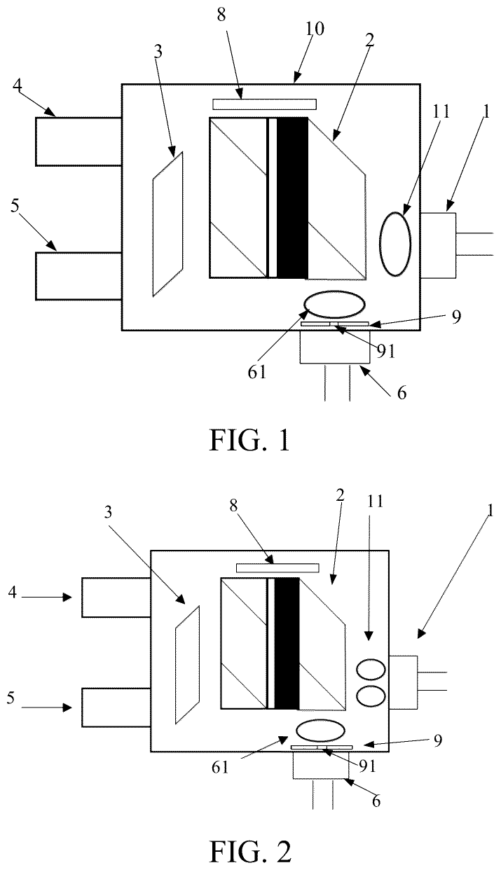

One or more embodiments provide a dual-port optical transmitting and receiving assembly. Referring to FIG. 1, the dual-port optical transmitting and receiving assembly includes an optical transmitting group 1, an optical circulator 2, a light turning element 3, a first input/output terminal 4, a second input/output terminal 5, and an optical receiving group 6.

A housing 10 is provided outside the dual-port optical transmitting and receiving assembly. The optical transmitting group 1 is provided at one end of the housing 10, and the first input/output terminal 4 and the second input/output terminal 5 are provided at the other end of the housing 10. The optical circulator 2 and the light turning element 3 are accommodated in the housing 10. The optical receiving group 6 is provided on the lower side of the housing 10. The optical receiving group 6 and the optical transmitting group 1 are distributed perpendicular to each other.

The optical transmitting group 1 is configured to emit laser signal light. In one or more embodiments, as shown in FIG. 1, the optical transmitting group 1 is a dual-path optical transmitting group with the same wavelength. Specifically, the dual-path optical transmitting group may emit a first signal light and a second signal light with the same wavelength. The dual-path optical transmitting group may achieve light separation of two channels by means of two built-in lenses with a spacing of 750 microns in a laser.

One or two first lenses 11 may also be provided in front of the dual-path optical transmitting group. The first lens 11 is configured to collimate the first signal light and the second signal light. Referring to FIG. 2, when there are two first lenses 11, the two first lenses 11 may be configured to collimate the first signal light and the second signal light, respectively. A signal light beam output from the optical transmitting group 1 uses collimated light instead of conventional converged light so that the coupling efficiency can be increased to reduce stray light due to coupling mismatch.

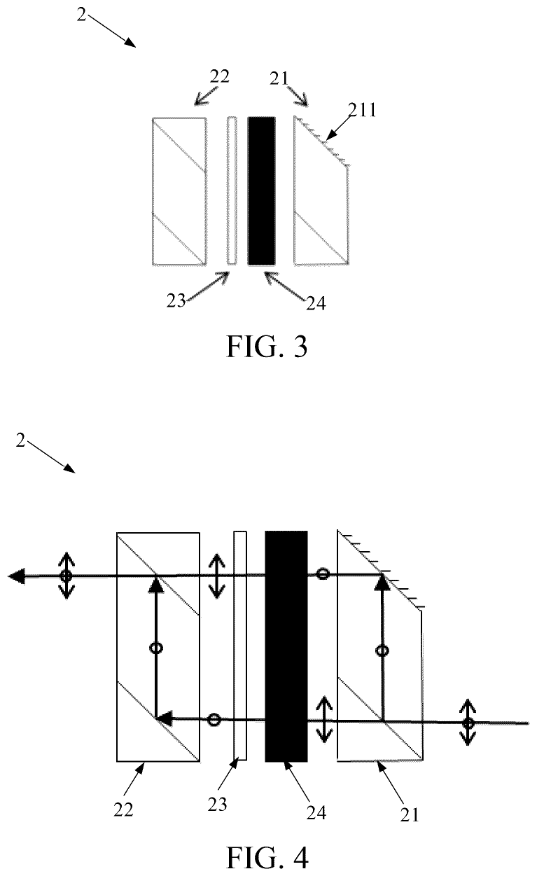

Referring to FIG. 3, the optical circulator 2 is a multi-port optical device having non-reciprocal characteristics. The optical circulator 2 includes two deflection beam splitters 21 and 22, a wave plate 23, and a Faraday rotator assembly 24. The two deflection beam splitters are a first polarization beam splitter 21 and a second polarization beam splitter 22, respectively. A total reflection surface 211 is provided in a partial region of the first polarization beam splitter 21, and a signal light can be totally reflected on the total reflection surface 211. The total reflection surface 211 may be provided with a high-reflection film or a non-plating film. The wave plate 23 may be a half-wave plate. The Faraday rotator assembly 24 may rotate the polarization state of light using the Faraday effect.

Referring to FIG. 1, specifically, the dual-port optical transmitting and receiving assembly further includes a light-absorbing plate 8. The light-absorbing plate 8 is provided on the side or upper side of the optical circulator 2 facing away from the optical receiving group 6, and the light-absorbing plate 8 is configured to absorb stray light and reduce the entrance of the stray light into the optical receiving group 6. The light-absorbing plate is made of a light-absorbing material.

The optical circulator 2 is provided in front of the optical transmitting group 1. The first signal light and the second signal light emitted from the optical transmitting group 1 enter the optical circulator 2.

FIG. 4 is a schematic optical path diagram of signal lights transmitted by the optical transmitting group 1 passing through the optical circulator 2. The first signal light or the second signal light is output from the optical transmitting group 1, is collimated by the first lens 11, separately enters the optical circulator 2, is split into two polarized lights by the first polarization beam splitter 21, then passes through the Faraday rotator assembly 24 and the wave plate 23 and is combined by the second polarization beam splitter 22 before exiting forward.

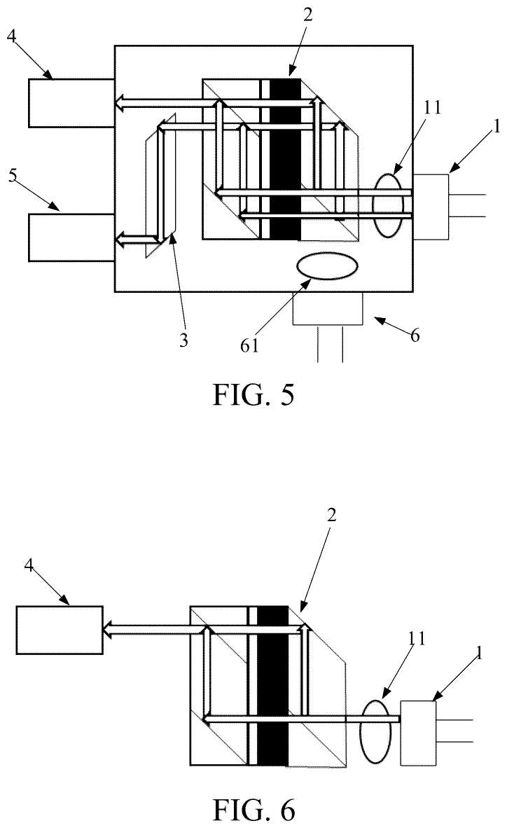

FIG. 5 is a schematic diagram of an optical path structure of the first signal light and the second signal light being transmitted from the dual-path optical transmitting group 1 to the first input/output terminal 4 and the second input/output terminal 5. There is a certain distance between the first signal light and the second signal light. Also, the first signal light and the second signal light exit in parallel to each other. After being collimated by the first lens 11, the first signal light and the second signal light enter the optical circulator 2 and exit from the side of the optical circulator 2 close to the first input/output terminal 4 with a distance therebetween in a vertical direction.

FIG. 6 is an optical path diagram of the first signal light. After passing through the optical circulator 2, the first signal light may directly enter the first input/output terminal 4.

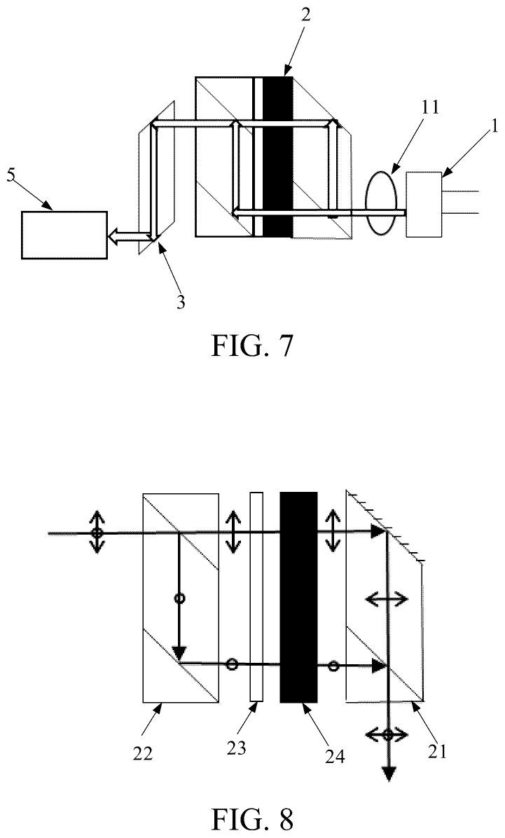

FIG. 7 is an optical path diagram of the second signal light. The second signal light passes through the optical circulator 2 and then enters the light turning element 3. The second signal light is reflected twice inside the light turning element 3 and exits from the side of the light turning element 3 close to the second input/output terminal 5 to enter the second input/output terminal 5.

Specifically, the shape of the light turning element 3 may be a parallelogram structure. Two short oblique sides of the parallelogram thereof may be reflective surfaces so that the second signal light may be reflected twice by the light turning element 3 and reach the second input/output terminal 5.

Both the first input/output terminal 4 and the second input/output terminal 5 may be configured to emit and receive signal light.

FIG. 8 is an optical path diagram of the third signal light or the fourth signal light of the dual-port optical transmitting and receiving assembly propagating in the optical circulator 2. When the third signal light or the fourth signal light enters the optical circulator 2, it first passes through the second polarization beam splitter 22 to be split into two polarized lights. Then, the two polarized lights pass through wave plate 23 and the Faraday rotator assembly 24, and finally, they are combined by the first polarization beam splitter 21 to exit downward and enter the optical receiving group 6.

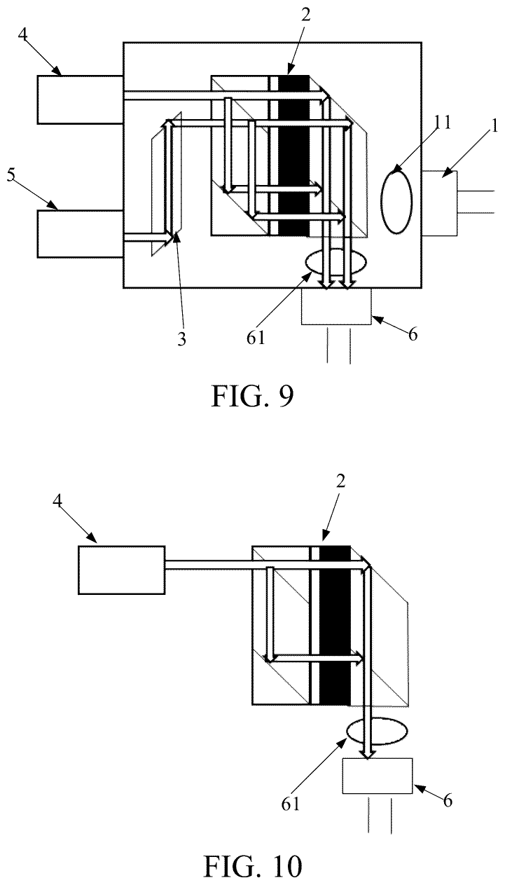

FIG. 9 is an optical path diagram of the third signal light and the fourth signal light being transmitted from the two input/output terminals to the optical receiving group. Lenses (not shown) are provided on light-passing surfaces of the first input/output terminal 4 and the second input/output terminal 5. Since inclined surfaces of the lenses thereof have a relatively large angle, the amount of misalignment between reflected stray light and the signal light increases due to the increase in the angles of the inclined surfaces, reducing the proportion of energy of the reflected stray light entering the optical receiving group 6, so that the signal-to-noise ratio may be improved.

FIG. 10 is an optical path diagram of the third signal light. The third signal light exits from the first input/output terminal 4 and directly enters the optical circulator 2. After passing through the optical circulator 2, the third signal light exits from the side of the optical circulator 2 close to the optical receiving group 6 and is converged by a second lens 61 and received by the optical receiving group 6.

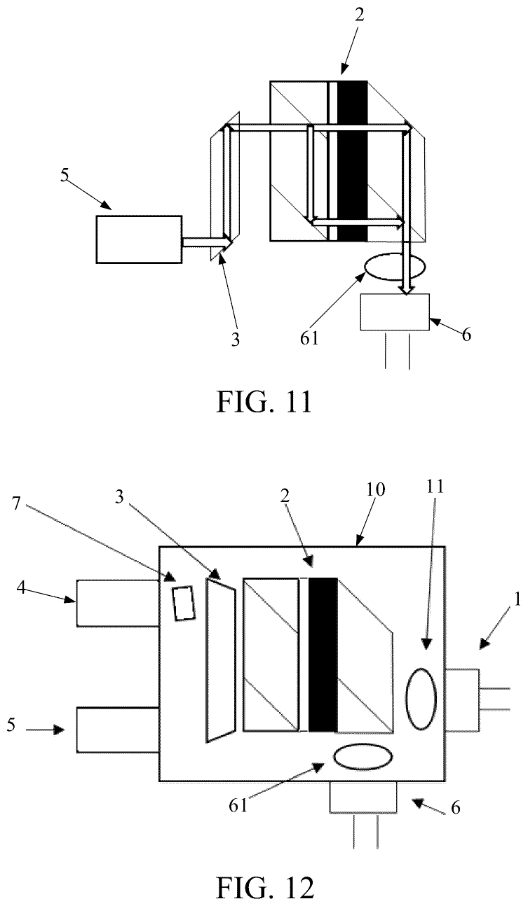

FIG. 11 is an optical path diagram of the fourth signal light. The fourth signal light exits from the second input/output terminal 5, is reflected twice by the light turning element 3, and then enters the optical circulator 2. The fourth signal light passes through the optical circulator 2, exits from the side of the optical circulator toward the optical receiving group 6, and is converged by the second lens 61 and received by the optical receiving group 6.

The optical receiving group 6 is configured to receive a signal light. A second lens 61 may be further provided in front of the optical receiving group 6. The second lens 61 is configured to converge the third signal light and the fourth signal light emitted from the first input/output terminal 4 and the second input/output terminal 5. The third signal light and the fourth signal light passing through the optical circulator 2 are converged by the second lens 61 and then enter the optical receiving group 6.

Specifically, the dual-port optical transmitting and receiving assembly may further include a diaphragm 9, as shown in FIG. 1. The diaphragm 9 is placed on the upper side of the optical receiving group 6. An opening 91 of the diaphragm 9 allows the third signal light and the fourth signal light to pass therethrough, and the portion other than the opening 91 is used to block stray light returning from an inclined surface of an optical fiber and an inclined surface of a lens. The surface of the diaphragm 9 is preferably covered with a light-absorbing material for absorbing stray light falling on the diaphragm 9. The light-absorbing material may prevent or reduce secondary reflections from entering the optical receiving group 6.

The first input/output terminal 4 may be configured to transmit the third signal light and receive the first signal light. The second input/output terminal 5 may be configured to transmit the fourth signal light and receive the second signal light. The first input/output terminal 4 and the second input/output terminal 5 are arranged side by side and spaced apart from each other. Specifically, the distance between the first input/output terminal 4 and the second input/output terminal 5 may be 6.25 mm, which may satisfy the requirements of the International Electrotechnical Commission standard IEC 61754-20.

As shown in FIGS. 5 and 9, the light turning element 3 is provided on a light exit side of the optical circulator 2 and a light incident side of the second input/output terminal 5. It can be understood that the light turning element 3 may be provided between the optical circulator 2 and the second input/output terminal 5.

The light turning element 3 is capable of reflecting the second signal light so that the second signal light enters the second input/output terminal 5. Moreover, the light turning element 3 may reflect the fourth signal light exiting from the second input/output terminal 5 so that the fourth signal light enters the optical circulator 2. In one or more embodiments, the light turning element 3 may be a prism.

In one or more embodiments, the light-passing surfaces of the optical circulator 2 and the light turning element 3 are preferably deflected at a certain angle with respect to the optical path and a deflection angle is formed between the light-passing surface of the optical circulator 2 and the light-passing surface of the light turning element 3. Due to the introduction of the deflection angle, the reflected stray light generated from the light-transmitting surfaces of the optical circulator 2 and the light turning element 3 is misaligned with the signal light so that the reflected stray light falls on the non-opening portion of the diaphragm 9 and cannot enter the optical receiving group 6 through the opening 91, which is advantageous for reducing the entrance of the stray light into the optical receiving group 6.

Moreover, at least one or more of the optical transmitting group 1, the optical circulator 2, the light turning element 3, the first input/output terminal 4, the second input/output terminal 5, and the optical receiving group 6 are provided with an anti-reflection film to reduce reflected stray light at the light-passing surface.

In one or more embodiments, the optical transmitting group 1 may be changed to a wavelength-adjustable optical transmitting group, and the wavelength of the first signal light is different from the wavelength of the second signal light. Then, the dual-port optical transmitting and receiving assembly is a dual-port optical transmitting and receiving assembly with a wavelength-adjustable design.

FIG. 12 is a schematic structural diagram of one or more embodiments of a dual-port optical transmitting and receiving assembly using a wavelength-adjustable optical transmitting group. The dual-port optical transmitting and receiving assembly with the wavelength-adjustable design further includes a filter 7.

The filter 7 is disposed between the first input/output terminal 4 and the optical circulator 2. This is because the first signal light and the second signal light have different wavelengths. The filter 7 may be disposed to transmit the first signal light and reflect the second signal light.

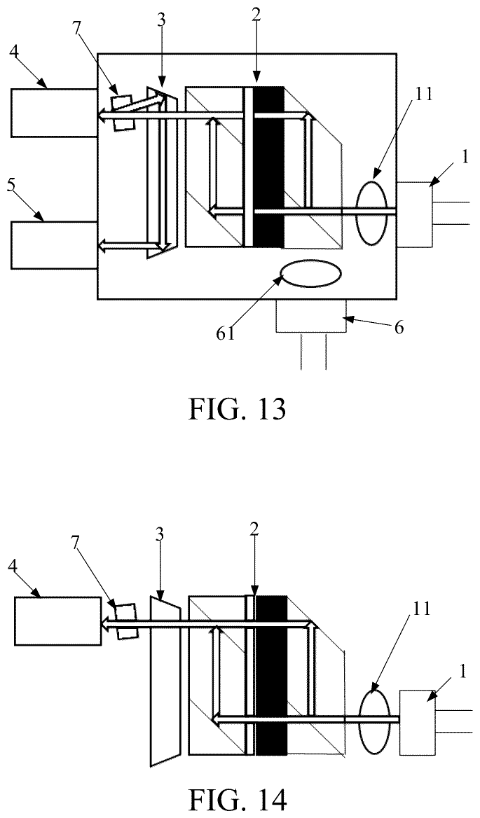

FIG. 13 is an optical path diagram of the first signal light and the second signal light exiting from the wavelength-adjustable optical transmitting group 1 and entering the first input/output terminal 4 and the second input/output terminal 5. The filter 7 transmits the first signal light and reflects the second signal light. The filter 7 may be disposed between the light turning element 3 and the first input/output terminal 4. The filter 7 is disposed opposite to the first input/output terminal 4.

FIG. 14 is a schematic diagram of an optical path of the first signal light from the optical transmitting group 1 to the first input/output terminal 4. After the first signal light passes through the optical circulator 2, the first signal light passes through the light turning element 3 and enters the filter 7. Then, the first signal light passes through the filter 7 and directly enters the first input/output terminal 4.

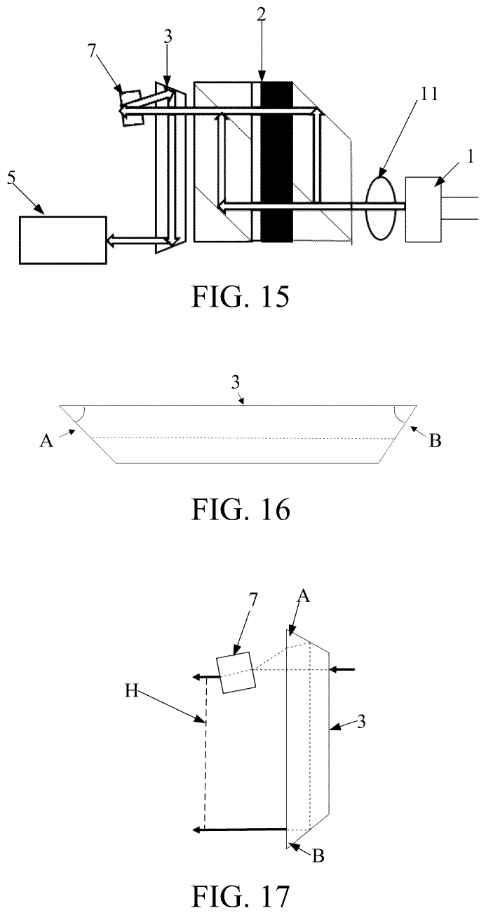

FIG. 15 is a schematic diagram of an optical path of the second signal light from the optical transmitting group 1 to the second input/output terminal 5. After passing through the optical circulator 2, the second signal light is reflected by the filter 7. Then it enters the light turning element 3 again, and the second signal light is guided to the second input/output terminal 5 after being reflected twice by the light turning element 3.

FIGS. 16 and 17 show the light turning element 3 in more detail. The light turning element 3 adopts an asymmetric trapezoidal structure. Two acute angles of the base of the trapezoid are angle A and angle B, wherein angle A and angle B are not equal in size, so that the effect of adjusting the optical path can be achieved. As shown in FIG. 16, specifically, the degree of angle A is less than the degree of angle B.

An optical path diagram of a signal light in the light turning element 3 and the filter 7 is shown in FIG. 17. After passing through the light turning element 3 and the filter 7, two outgoing lights are parallel with spacing H of 6.25 mm. Then, the distance between the first input/output terminal 4 and the second input/output terminal 5 may also be 6.25 mm.

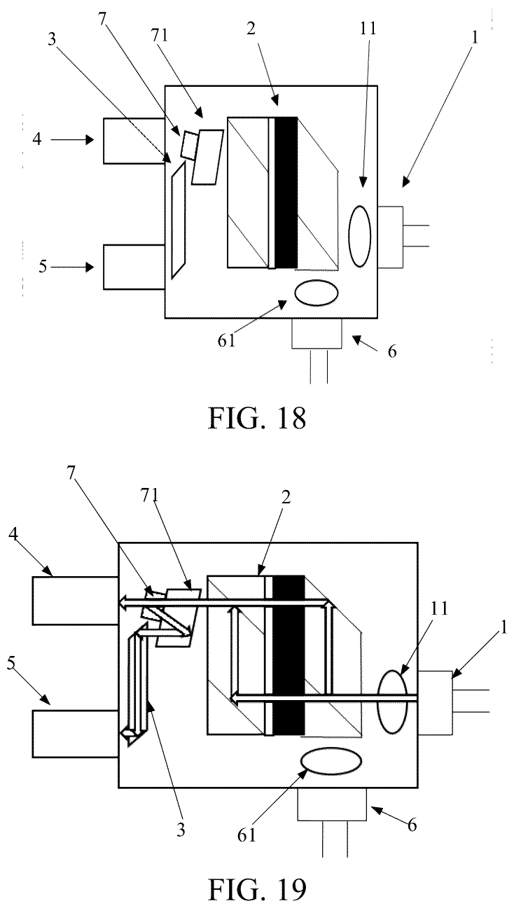

FIG. 18 is a schematic structural diagram of a dual-port optical transmitting and receiving assembly with a wavelength-adjustable optical transmitting group according to one or more embodiments. FIG. 19 is a schematic diagram of the optical paths of two signal lights being transmitted from the wavelength-adjustable optical transmitting group 1 to the first input/output terminal 4 and the second input/output terminal 5 in the dual-port optical transmitting and receiving assembly shown in FIG. 18.

In FIG. 18, the filter 7 is disposed in the upper half of an optical shift element 71 so as to constitute a filter assembly. The filter assembly includes an optical shift element 71 close to the optical circulator 2 and a filter 7 facing away from the optical circulator 2. The light shift element 71 has a parallelogram shape, and the side thereof attached to the filter 7 is gradually inclined from bottom to top toward the optical circulator 2. The filter assembly is disposed between the first input/output terminal and the optical circulator 2. The filter 7 may be set to transmit the first signal light and reflect the second signal light.

Referring to FIG. 19, after the first signal light and the second signal light pass through the optical circulator 2, the first signal light and the second signal light pass through the optical shift element 71 and enter the filter 7. The first signal light is transmitted through the filter 7 and enters the first input/output terminal 4. After being reflected by the filter 7, the second signal light again enters the optical shift element 71. After being reflected by the optical shift element 71 and shifted downward by a distance, the second signal light enters the light turning element 3, and the second signal light is guided to the second input/output terminal 5 through the optical path-turning action of the light turning element 3. Preferably, the optical shift element 71 is provided with an anti-reflection film at a partial region for the first signal light and the second signal light to be incident, on a side facing the optical circulator 2, and is provided with a high-reflection film at another partial region for the second signal light to be reflected, which is thus advantageous for improving the signal quality.

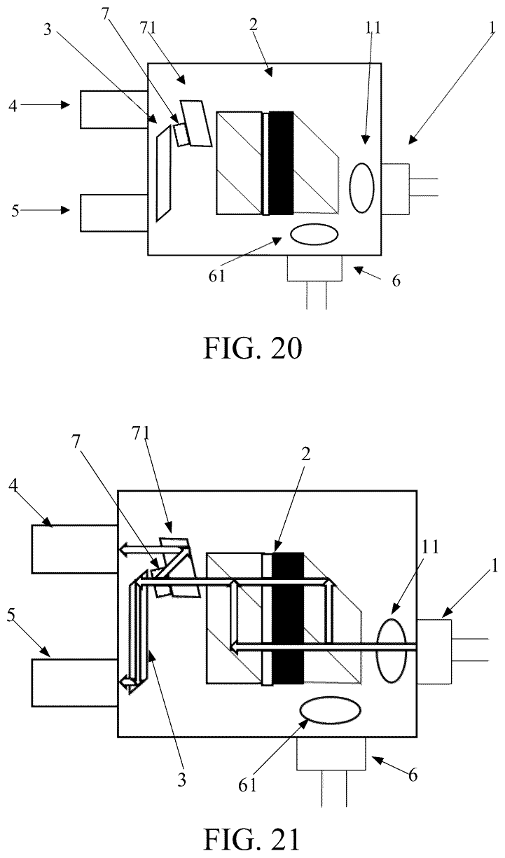

FIG. 20 is a schematic structural diagram of one or more embodiments of the dual-port optical transmitting and receiving assembly using the wavelength-adjustable optical transmitting group. FIG. 21 is an optical path diagram of a signal light being transmitted from the wavelength-adjustable optical transmitting group 1 to the first input/output terminal 4 and the second input/output terminal 5 in the dual-port optical transmitting and receiving assembly shown in FIG. 20.

In FIG. 20, the filter 7 is disposed in the lower half of the light shift element 71 so as to constitute a filter assembly. The light shift element 71 has a parallelogram shape, and the side thereof attached to the filter 7 is gradually inclined from top to bottom toward the optical circulator 2. The filter 7 is disposed to reflect the first signal light and transmit the second signal light.

Referring to FIG. 21, after the first signal light and the second signal light pass through the optical circulator 2, the first signal light and the second signal light pass through the optical shift element 71 and enter the filter 7. After being reflected by the filter 7, the first signal light enters the optical shift element 71 again, is reflected by the optical shift element 71, and exits toward the first input/output terminal 4. The second signal light is transmitted through the filter 7 to enter the light turning element 3, and the second signal light is guided to the second input/output terminal 5 through the light path turning action of the light turning element 3. Preferably, the optical shift element 71 is provided with an anti-reflection film at a partial region for the first signal light and the second signal light to be incident, on a side facing the optical circulator 2, and is provided with a high-reflection film at another partial region for the first signal light to be reflected, which is thus advantageous for improving the signal quality.

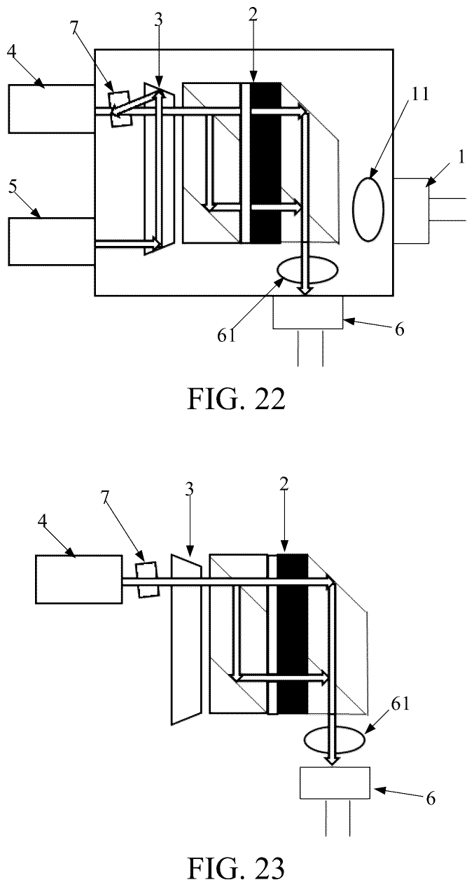

FIG. 22 is an optical path diagram of a third signal light and a fourth signal light of the dual-port optical transmitting and receiving assembly shown in FIG. 12. The third signal light and the fourth signal light are emitted from the first input/output terminal 4 and the second input/output terminal 5, respectively, and are finally all received by the optical receiving group 6.

FIG. 23 is an optical path diagram of the third signal light. The third signal light exits from the first input/output terminal 4, is transmitted through the filter 7 and the light turning element 3 and enters the optical circulator 2. After passing through the optical circulator 2, the third signal light finally exits from the side of the optical circulator 2 close to the optical receiving group 6 and is converged by the second lens 61 and received by the optical receiving group 6.

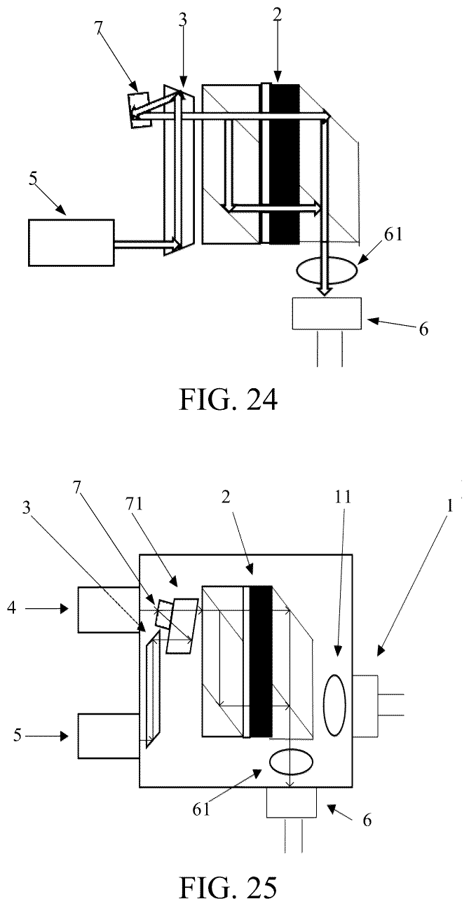

FIG. 24 is an optical path diagram of the fourth signal light. The fourth signal light exits from the second input/output terminal 5, is reflected twice by the light turning element 3 to enter the filter 7, and then reflected by the filter 7 to enter the optical circulator 2. The fourth signal light is reflected by the optical circulator 2, finally exists from the side of the optical circulator 2 close to the optical receiving group 6 and is converged by the second lens 61 and received by the optical receiving group 6.

FIG. 25 is an optical path diagram of the third signal light and the fourth signal light of the dual-port optical transmitting and receiving assembly shown in FIG. 18. The third signal light exits from the first input/output terminal 4, passes through the filter 7 and the light turning element 3, and enters the optical circulator 2. The fourth signal light exits from the second input/output terminal 5, is reflected twice by the light turning element 3, enters the optical shift element 71, is reflected by the optical shift element 71 to enter the filter 7, is reflected by the filter 7 and then enters the optical shift element 71 again, and then passes through the optical shift element 71 to enter the optical circulator 2. After passing through the optical circulator 2, the third signal light and the fourth signal light finally exit from the side of the optical circulator 2 close to the optical receiving group 6 and are converged by the second lens 61 and received by the optical receiving group 6.

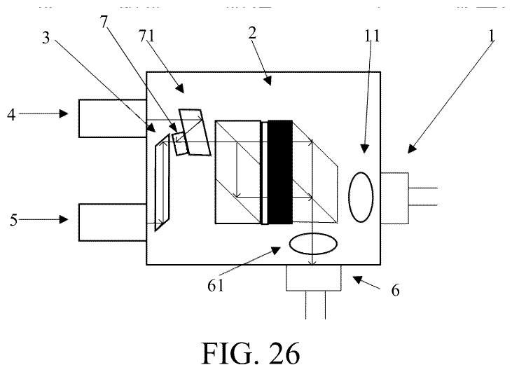

FIG. 26 is an optical path diagram of the third signal light and the fourth signal light of the dual-port optical transmitting and receiving assembly shown in FIG. 20. The third signal light exits from the first input/output terminal 4, is first reflected by the optical shift element 71 to the filter 7, then reflected by the filter and then enters the optical shift element 71 again, and then passes through the optical shift element 71 to enter the optical circulator 2. The fourth signal light exits from the second input/output terminal 5, is reflected twice by the light turning element 3 to enter the filter 7, sequentially passes through the filter 7 and the optical shift element 71, and then enters the optical circulator 2. After passing through the optical circulator 2, the third signal light and the fourth signal light finally exit from the side of the optical circulator 2 close to the optical receiving group 6 and are converged by the second lens 61 and received by the optical receiving group 6.

In the dual-port optical transmitting and receiving assembly shown in FIG. 12, the first signal light transmitted from the optical transmitting group 1 to the first input/output terminal 4, as shown in FIG. 14, and the third signal light transmitted from the first input/output terminal 4 to the optical receiving group 6 as shown in FIG. 23 are a group of signal lights having the same wavelength.

The second signal light is transmitted from the optical transmitting group 1 to the second input/output terminal 5, as shown in FIG. 15. The fourth signal light which is transmitted from the second input/output terminal 5 to the optical receiving group 6 as shown in FIG. 24, is another group of signal lights having the same wavelength.

However, the wavelength of the third signal light emitted from the first input/output terminal 4 may be different from that of the fourth signal light emitted from the second input/output terminal 5. For example, the wavelengths of the first signal light and the third signal light may both be 1625 nm. The wavelengths of the second signal light and the fourth signal light may both be 1627 nm.

By means of the two-path optical transmitting group, the optical circulator 2 and the light turning element 3, the above dual-port optical transmitting and receiving assembly can realize that the first signal light and the second signal light are transmitted from the optical transmitting group 1 to the first input/output terminal 4 and the second input/output terminal 5, respectively. They can also realize that the third signal light and the fourth signal light are transmitted from the first input/output terminal 4 and the second input/output terminal 5 to the optical receiving group 6, respectively. Therefore, the dual-port optical transmitting and receiving assembly of the one or more embodiments includes four optical paths, and signal lights of different wavelengths can be used for both an input channel and an output channel, thereby greatly improving the channel utilization rate. Also, the size of the above dual-port optical transmitting and receiving assembly can be compatible with the small form factor pluggable-dual density (SFP-DD) multi-source agreement (MSA) standard, and the cost can be greatly reduced. Meanwhile, the four optical paths all use the same set of light-splitting core components: the optical circulator 2 and the light turning element 3, achieving an extremely high degree of integration, improving the space utilization rate, making it possible to be compatible with the standard of the SFP hot-pluggable module in terms of size, and greatly reducing the cost.

In addition, the dual-port optical transmitting and receiving assembly of one or more embodiments uses the optical circulator 2 to perform transmission and reception of the optical path. It has characteristics of low loss and insensitivity to the polarization state of the transmitted and received signal light. It may be applied to an application scenario where high demands are placed on the channel utilization rate, space, cost, and loss, such as a highly integrated optical time domain reflectometer (OTDR).

While the present disclosure has been described with reference to several typical embodiments, it should be understood that the terms used are illustrative and exemplary rather than restrictive terms. Since the present disclosure can be specifically implemented in various forms without departing from the spirit or essence of the present disclosure, it should be understood that the above embodiments are not limited to any of the foregoing details but should be broadly interpreted within the spirit and scope defined by the attached claims. Therefore, all changes and modifications falling within the scope of the claims or their equivalents should be covered by the attached claims.

1. A dual-port optical transmitting and receiving assembly, comprising:
an optical transmitting group, an optical circulator, a light turning element, a first input/output terminal, a second input/output terminal, and an optical receiving group, wherein the first input/output terminal and the second input/output terminal are disposed in a spaced arrangement;
a first signal light is emitted by the optical transmitting group, wherein the first signal light passes through the optical circulator and then enters the first input/output terminal;
a second signal light is emitted by the optical transmitting group, wherein the second signal light passes through the optical circulator and then enters the second input/output terminal after being reflected by the light turning element;
a third signal light is received from the first input/output terminal, wherein the third signal light passes through the optical circulator and then enters the optical receiving group; and
a fourth signal light is received from the second input/output terminal, wherein the fourth signal light is reflected by the light turning element and then enters the optical receiving group after passing through the optical circulator.

2. The dual-port optical transmitting and receiving assembly according to claim 1, wherein the optical transmitting group is a wavelength-adjustable optical transmitting group, and the first signal light has a wavelength different from that of the second signal light.

3. The dual-port optical transmitting and receiving assembly according to claim 2, further comprises a filter disposed between the first input/output terminal and the light turning element, wherein:
the first signal light passes through the light turning element and the filter and then enters the first input/output terminal, and
the second signal light is reflected by the filter, then enters the light turning element again and enters the second input/output terminal after being reflected by the light turning element.

4. The dual-port optical transmitting and receiving assembly according to claim 3, wherein the light turning element has an outer shape of an asymmetric trapezoid, and two angles of a base of the asymmetric trapezoid are not equal in size.

5. The dual-port optical transmitting and receiving assembly according to claim 2, further comprises a filter assembly disposed between the optical circulator and the light turning element, wherein the filter assembly comprises an optical shift element close to the optical circulator and a filter facing away from the optical circulator.

6. The dual-port optical transmitting and receiving assembly according to claim 5, wherein a first one of the first signal light and the second signal light passing through the optical shift element may pass through the filter, and a second one of the first signal light and second signal light enters the optical shift element again after being reflected by the filter, and leaves the optical shift element after being reflected and shifted by a certain distance by the optical shift element.

7. The dual-port optical transmitting and receiving assembly according to claim 5, wherein the light turning element has a shape of a parallelogram, and the optical shift element is provided with an anti-reflection film in a partial region on a side facing the optical circulator, and a high-reflection film in another partial region.

8. The dual-port optical transmitting and receiving assembly according to claim 1, wherein the optical transmitting group is a dual-path optical transmitting group, and the first signal light and the second signal light have a same wavelength.

9. The dual-port optical transmitting and receiving assembly according to claim 8, wherein the first signal light and the second signal light exit in parallel and have a distance therebetween.

10. The dual-port optical transmitting and receiving assembly according to claim 8, wherein the light turning element has a shape of a parallelogram.

11. The dual-port optical transmitting and receiving assembly according to claim 1, further comprises a light-absorbing plate disposed on a side of the optical circulator facing away from the optical receiving group, and the light-absorbing plate is configured to absorb stray light and reduce entrance of the stray light into the optical receiving group.

12. The dual-port optical transmitting and receiving assembly according to claim 1, further comprises a diaphragm disposed between the optical circulator and the optical receiving group, wherein the diaphragm is provided with an opening to allow the third signal light and the fourth signal light to pass therethrough.

13. A system for making a dual-port optical transmitting and receiving assembly comprising:
an optical transmitting group, an optical circulator, a light turning element, a first input/output terminal, a second input/output terminal, and an optical receiving group, wherein the first input/output terminal and the second input/output terminal are disposed in a spaced arrangement;
a first signal light is emitted by the optical transmitting group, wherein the first signal light passes through the optical circulator and then enters the first input/output terminal;
a second signal light is emitted by the optical transmitting group, wherein the second signal light passes through the optical circulator and then enters the second input/output terminal after being reflected by the light turning element;
a third signal light is received from the first input/output terminal, wherein the third signal light passes through the optical circulator and then enters the optical receiving group; and
a fourth signal light is received from the second input/output terminal, wherein the fourth signal light is reflected by the light turning element and then enters the optical receiving group after passing through the optical circulator.

14. The system of claim 13, wherein the optical transmitting group is a wavelength-adjustable optical transmitting group, and the first signal light has a wavelength different from that of the second signal light.

15. The system of claim 14, further comprising a filter disposed between the first input/output terminal and the light turning element, wherein:
the first signal light passes through the light turning element and the filter and then enters the first input/output terminal, and
the second signal light is reflected by the filter, then enters the light turning element again, and enters the second input/output terminal after being reflected by the light turning element.

16. The system of claim 15, wherein the light turning element has an outer shape of an asymmetric trapezoid, and two angles of a base of the asymmetric trapezoid are not equal in size.

17. The system of claim 14, further comprises a filter assembly disposed between the optical circulator and the light turning element, wherein the filter assembly comprises an optical shift element close to the optical circulator and a filter facing away from the optical circulator.

18. The system of claim 13, wherein the optical transmitting group is a dual-path optical transmitting group, and the first signal light and the second signal light have a same wavelength.

19. The system of claim 13, further comprises a light-absorbing plate disposed on a side of the optical circulator facing away from the optical receiving group, and the light-absorbing plate is configured to absorb stray light and reduce entrance of the stray light into the optical receiving group.

20. The system of claim 13, further comprising a diaphragm disposed between the optical circulator and the optical receiving group, wherein the diaphragm is provided with an opening to allow the third signal light and the fourth signal light to pass therethrough.
